(19) United States
(12) Patent Application Publication
(10) Pub. No.: US 2012/0026141 A1
(43) Pub. Date: Feb. 2, 2012

(54) Bistable display apparatus and driving method

(76) Inventor: Feng-Ting Pai, Hsinchu City (TW)

(21) Appl. No.: 12/946,866

(22) Filed: Nov. 16, 2010

(30) Foreign Application Priority Data
Jul. 30, 2010 (TW) 099125425

(51) Int. Cl. G09G 5/00; G09G 3/34; G02F 1/167

(52) U.S. Cl. 345/208; 359/296; 345/107

(57) ABSTRACT

A bistable display with dot-matrix pixels is disclosed. The bistable display includes a front substrate, a plurality of first conductive electrodes, an electrophoretic medium layer, a plurality of second conductive electrodes, and a back substrate. The plurality of first conductive electrodes is disposed below the front substrate and parallel to each other along a first direction. The electrophoretic medium layer is disposed below the front substrate and the plurality of first conductive electrodes. The plurality of second conductive electrodes is disposed on the back substrate and parallel to each other along a second direction different from the first direction. A pixel is formed at each intersection of each first conductive electrode and each second conductive electrode.

### BACKGROUND OF THE INVENTION

1. Field of the Invention

The present invention relates to a bistable display and driving method, and more particularly, to a bistable display with dot-matrix pixels and related driving method.

2. Description of the Prior Art

Electro-phoretic Display (EPD) technology, also known as electronic paper (E-paper), combines the advantages of display functionality of traditional paper and the updatability of digital electronic mediums. Moreover, the EPD technology has low power consumption and a bistable characteristic, and is capable of being realized on a flexible substrate.

Please refer to FIG. 1, which is a schematic diagram of a conventional EPD apparatus 10. The EPD apparatus 10 includes a front substrate 102, a transparent conduct layer 104, an electrophoretic medium layer 106, an adhesive layer 108, a conductive electrode layer 110, and a back substrate 112. The transparent conduct layer 104 and the electrophoretic medium layer 106 are disposed on the front substrate 102 successively to form a front plane portion. The conductive electrode layer 110 is disposed on the back substrate 112 to form a back plane portion. The adhesive layer 108 is placed between the front plane portion and the back plane portion. Through a lamination manufacturing process, the front plane portion and the back plane portion can be bound together via the adhesive layer 108 so that the EPD apparatus 10 is finished. In general, the position of the charged particles in the electrophoretic medium layer 106 can be changed by applying an external voltage to the transparent conduct layer 104 and the conductive electrode layer 110 to display a color contrast between the charged particles and the electrophoretic medium, for representing different grey levels of the displayed frame. Therefore, the transparent conduct layer 104 and the conductive electrode layer 110 are regarded as two electrodes, and all display contents can be decided according to relative voltage levels of each. For example, please refer to FIG. 2, which is a schematic diagram of optical properties of the EPD apparatus 10 shown in FIG. 1. Suppose when the electrophoretic medium layer 106 is in a positive electric field, the EPD apparatus 10 displays white, and when the electrophoretic medium layer 106 is in a negative electric field, the EPD apparatus 10 displays black. For the same driving conditions (ex. in the same writing time situation), a hysteresis property exists when the reflectance is from low to high or from high to low. As shown in FIG. 2, the intermediate voltage region may stay at the original reflectance value until the voltage difference between the conductive electrode layer 110 and the transparent conduct layer 104 reaches a threshold voltage value (+Vth volts or −Vth volts). This means that when the voltage difference of the conductive electrode layer 110 and the transparent conduct layer 104 reaches the threshold voltage value (+Vth volts or −Vth volts), the reflectance value may be further changed into a target reflectance value. For example, as the voltage difference between the conductive electrode layer 110 and the transparent conduct layer 104 reaches a positive operating voltage value +Vop volts, the EPD apparatus 10 displays from black to white. Similarly, as the voltage difference between the conductive electrode layer 110 and the transparent conduct layer 104 reaches a positive operating voltage value −Vop volts, the EPD apparatus 10 displays from white to black.

On the other hand, for displaying complicated and random information content, the conventional display apparatus often represents image data as a dot matrix. For example, a thin film transistor array is often applied for a backplane. However, the thin film transistor array is usually a multi-layer structure made of different materials, such as conductor, semiconductor and insulating layers. In other words, the thin film transistor array may need a complicated semiconductor manufacturing process and consume high manufacturing cost. Moreover, the thin film transistor array can not be applied on a flexible substrate.

### SUMMARY OF THE INVENTION

It is therefore an objective of the present invention to provide a bistable display with dot-matrix pixels and driving method.

The present invention discloses a bistable display apparatus with dot-matrix pixels, which the bistable display apparatus includes a front substrate; a plurality of first conductive electrodes disposed below the front substrate and parallel to each other along a first direction; an electrophoretic medium layer disposed below the front substrate and the plurality of first conductive electrodes; a back substrate; and a plurality of second conductive electrodes disposed on the back substrate and parallel to each other along a second direction different from the first direction; wherein a pixel is formed at each intersection of each first conductive electrode and each second conductive electrode.

The present invention further discloses a bistable display apparatus with dot-matrix pixels, which the bistable display apparatus includes a front substrate; a plurality of first conductive electrodes disposed below the front substrate and parallel to each other along a first direction; an electrophoretic medium layer disposed below the front substrate and the plurality of first conductive electrodes; a back substrate; and a plurality of second conductive electrodes disposed on the back substrate and parallel to each other along a second direction different from the first direction, wherein a pixel is formed at each intersection of each first conductive electrode and each second conductive electrode; a timing control circuit for generating a data control signal and a driving control signal according to image data; a data driving circuit coupled to the timing control circuit and the plurality of second conductive electrodes for generating a plurality of data driving signals to the plurality of second conductive electrodes according to the data control signal; and a scan driving circuit coupled to the timing control circuit and the plurality of first conductive electrodes for generating a plurality of scan driving signals to the plurality of first conductive electrodes according to the driving control signal.

The present invention further discloses a driving method for a bistable display apparatus, which the driving method includes providing the bistable display apparatus, the bistable display apparatus comprising a front substrate, a plurality of first conductive electrodes disposed below the front substrate and parallel to each other along a first direction, an electrophoretic medium layer disposed below the front substrate and the plurality of first conductive electrodes, a back substrate, and a plurality of second conductive electrodes disposed on the back substrate and parallel to each other along a second direction different from the first direction, wherein a pixel is formed at each intersection of each first conductive electrode and each second conductive electrode; generating a data control signal and a driving control signal according to image data; generating a plurality of data driving signals to the plurality of second conductive electrodes according to the data control signal; and generating a plurality of scan driving signals to the plurality of first conductive electrodes according to the driving control signal.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a conventional EPD apparatus.

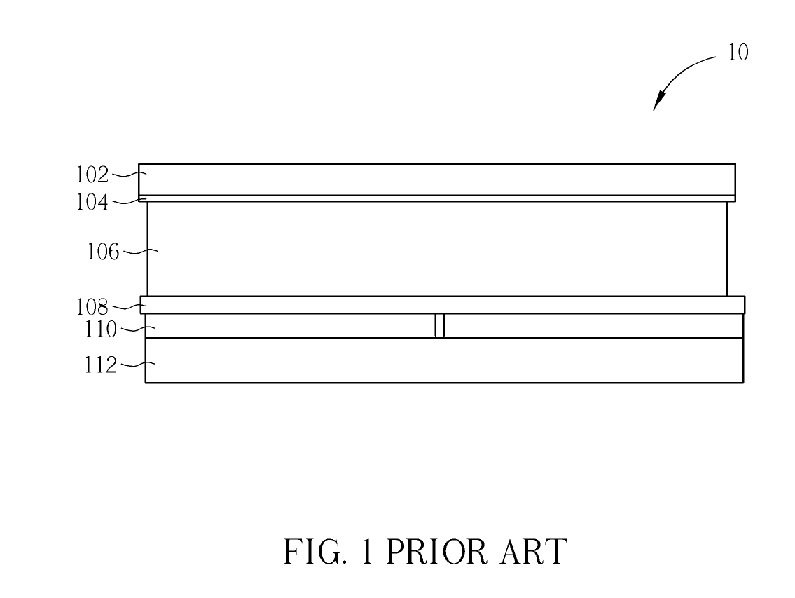

FIG. 2 is a schematic diagram of optical properties of the EPD apparatus shown in FIG. 1.

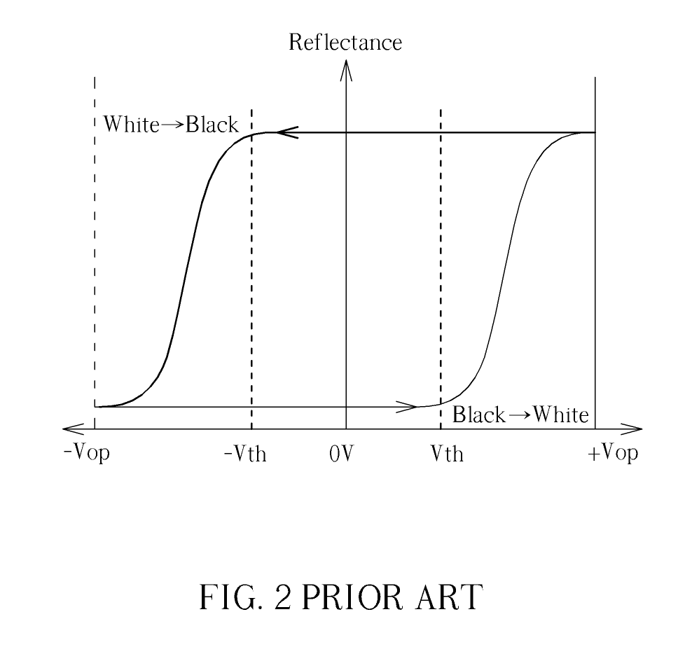

FIG. 3 is a schematic diagram of a bistable display apparatus with dot-matrix pixel according to an embodiment of the present invention.

FIG. 4 is a schematic diagram of dot-matrix pixel structure of the bistable display apparatus shown in FIG. 3.

FIG. 5 is a schematic diagram of the driving procedure according to an embodiment of the invention.

FIG. 6 is a true value table of the data driving signals and the scan driving signals according to an embodiment of the present invention.

FIG. 7 is a timing chart of the data driving signals and the scan driving signals according to an embodiment of the present invention.

FIG. 8 is a schematic diagram of pixel display according to an embodiment of the present invention.

FIG. 9 is a timing chart of relative signals under multiple scan operation according to an embodiment of the present invention.

### DETAILED DESCRIPTION

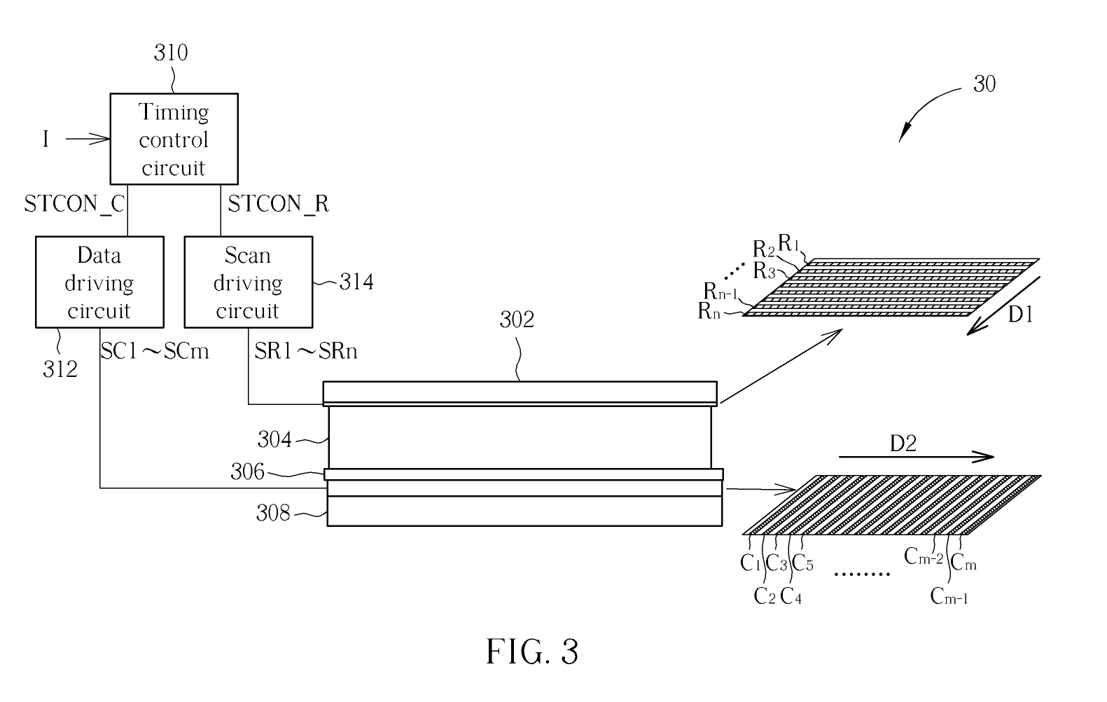

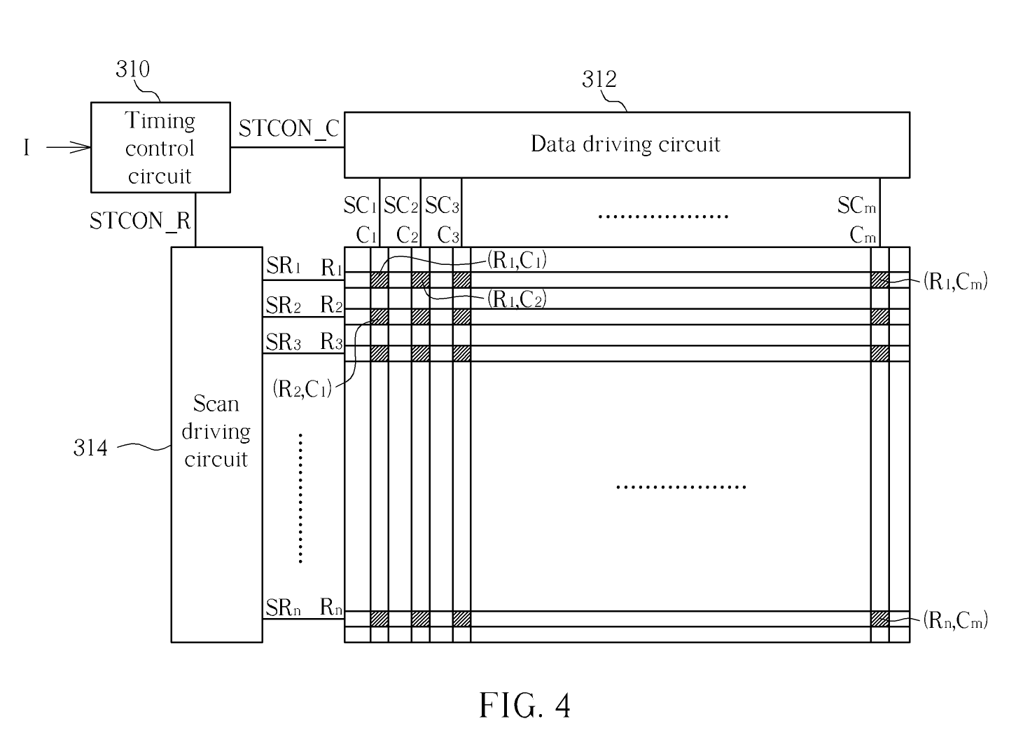

Please refer to FIG. 3 and FIG. 4. FIG. 3 is a schematic diagram of a bistable display apparatus 30 with dot-matrix pixels according to an embodiment of the present invention. FIG. 4 is a schematic diagram of dot-matrix pixel structure of the bistable display apparatus 30 shown in FIG. 3. The bistable display apparatus 30 includes a front substrate 302, an electrophoretic medium layer 304, an adhesive layer 306, aback substrate 308, a timing control circuit 310, a data driving circuit 312, a scan driving circuit 314, first conductive electrodes R1 to Rn, and second conductive electrodes C1 to Cm. As shown in FIG. 3, the first conductive electrodes R1 to Rn are disposed below the front substrate 302 and parallel to each other along a first direction D1. The second conductive electrodes C1 to Cm are disposed on the back substrate 308 and parallel to each other along a second direction D2. As a result, the first conductive electrodes R1 to Rn and second conductive electrodes C1 to Cm are arranged in a crossing manner. For each intersection of the first conductive electrode and the second conductive electrode, the desired color display is able to be realized with the corresponding variation of voltage difference. In other words, referring to FIG. 4, one pixel is formed at each intersection of each first conductive electrode and each second conductive electrode. Each pixel can display the corresponding grey level according to electric potential difference of the corresponding first conductive electrode and second conductive electrode. For example, as shown in FIG. 4, the bistable display apparatus 30 is capable of providing an image display comprising m by n pixels.

In brief, for application requirements of the dot matrix display apparatus, the present invention utilizes a patterned arrangement structure of the first conductive electrodes and second conductive electrodes to replace the conventional entire transparent conductive layer for forming a pixel array, and therefore, the bistable display apparatus 30 of the present invention can achieve the image display by pixel array accordingly based on the electro-phoretic display technology. Compared with the conventional dot matrix display with thin film transistor array, the present invention requires only a simple lamination manufacturing process to achieve a dot matrix pixel structure without a complicated semiconductor manufacturing process, reducing the manufacturing cost greatly. Furthermore, because the electro-phoretic display is adapted to be applied to a flexible substrate, the bistable display apparatus 30 of the present invention will be able to provide the user a more convenient portable display product.

Note that, the first conductive electrodes R1 to Rn can be electrodes composed of indium tin oxide or indium zinc oxide, and this should not be a limitation of the invention. The second conductive electrodes C1 to Cm can be electrodes composed of metal or other conductor, and this should not be a limitation of the invention. In addition, the front substrate 302 or the back substrate 308 can be a flex substrate, a printed circuit board, a substrate composed of glass material, or any other substrate capable of being installed with electrodes. On the other hand, the first direction D1 is different from the second direction D2, and the first direction D1 is not parallel to the second direction D2. Those skilled in the art can observe that the various variations of the first direction D1 and the second direction D2 can be adopted without departing from the spirit of the present invention.

Furthermore, please further refer to FIGS. 3 and 4. The timing control circuit 310 can generate a data control signal STCON_C and a driving control signal STCON_R according to image data I. The data driving circuit 312 is coupled to the timing control circuit 310 and the second conductive electrodes C1 to Cm for generating data driving signals SC1 to SCm to the second conductive electrodes C1 to Cm respectively according to the data control signal STCON_C. The scan driving circuit 314 is coupled to the timing control circuit 310 and the first conductive electrodes R1 to Rn for generating scan driving signals SR1 to SRn to the first conductive electrodes R1 to Rn according to the driving control signal STCONR_R. Therefore, each pixel is capable of displaying the corresponding grey level according to the electrical potential difference of the data driving signal and the scan driving signal. By collaborative operation of the timing control circuit 310, the data driving circuit 312, and the scan driving circuit 314, the image data I can be displayed on the pixels (m×n) of the bistable display apparatus 30.

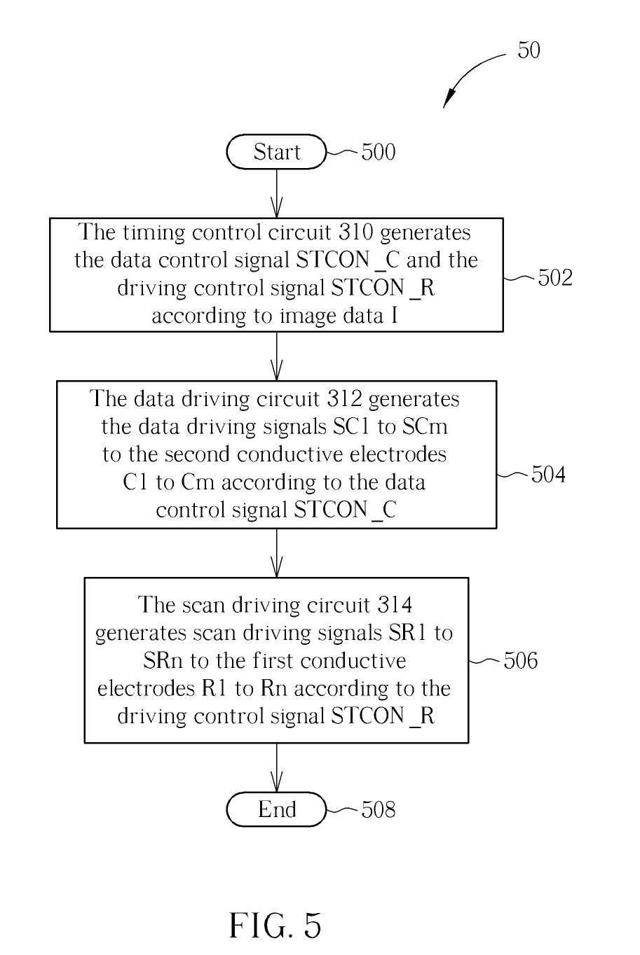

Operations of the bistable display apparatus 30 may be summarized in a driving procedure 50 shown in FIG. 5. Please refer to FIG. 5, which is a schematic diagram of the driving procedure 50 according to an embodiment of the invention. The driving procedure 50 comprises the following steps:

Step 500: Start.

Step 502: The timing control circuit 310 generates the data control signal STCON_C and the driving control signal STCON_R according to image data I.

Step 504: The data driving circuit 312 generates the data driving signals SC1 to SCm to the second conductive electrodes C1 to Cm according to the data control signal STCON_C.

Step 506: The scan driving circuit 314 generates scan driving signals SR1 to SRn to the first conductive electrodes R1 to Rn according to the driving control signal STCON_R.

Step 508: End.

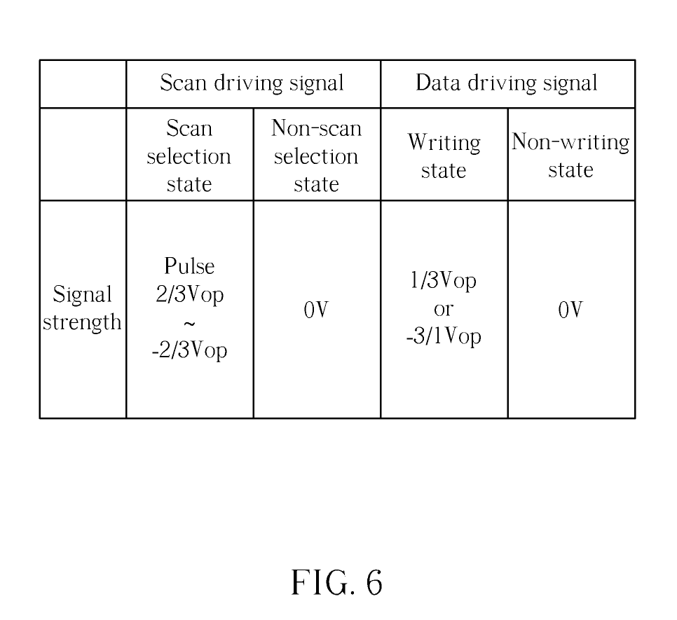

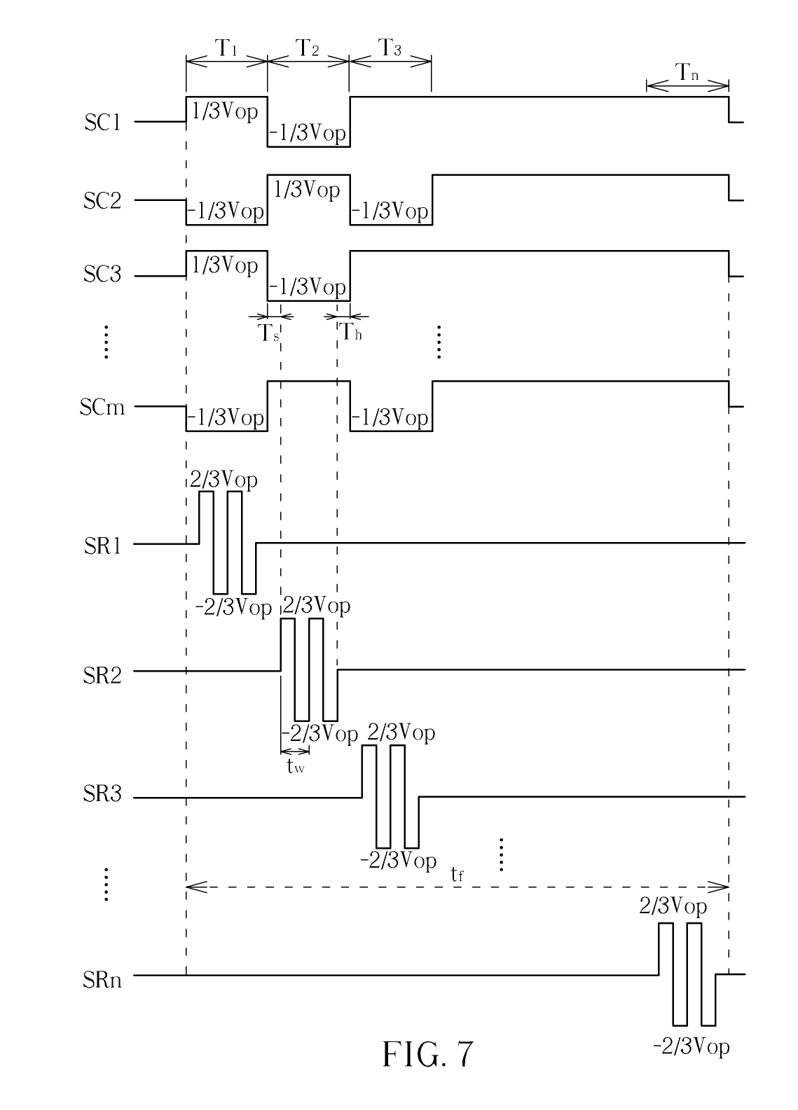

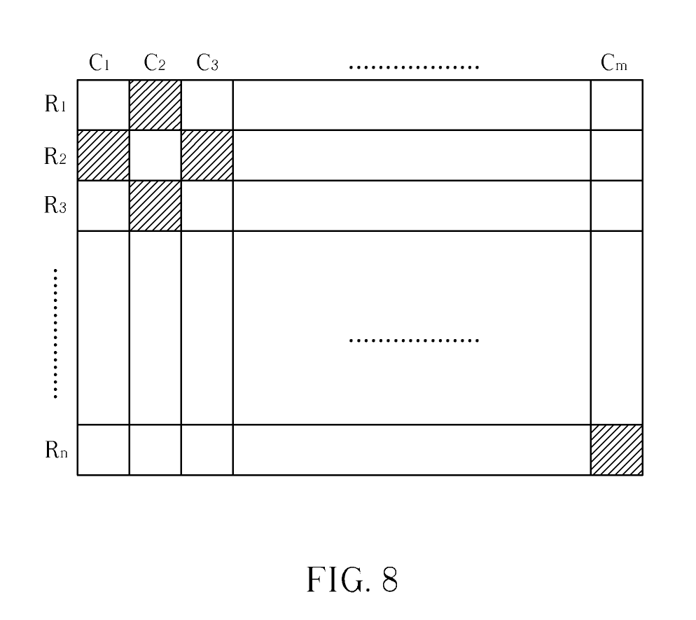

Please refer to FIG. 6 to FIG. 8. FIG. 6 is a true value table of the data driving signals and the scan driving signals according to an embodiment of the present invention. FIG. 7 is a timing chart of the data driving signals and the scan driving signals according to an embodiment of the present invention. FIG. 8 is a schematic diagram of pixel display according to an embodiment of the present invention. Suppose a positive threshold voltage value is +Vth volts, and a negative threshold voltage value is −Vth volts. A positive operating voltage value +Vop is greater than the positive threshold voltage value +Vth, and a negative operating voltage value −Vop is smaller than the negative threshold voltage value −Vth. As the voltage difference between the second conductive and the first conductive electrode reaches the positive operating voltage value +Vop or the negative operating voltage value −Vop, the target reflectance is therefore achieved, so that the corresponding pixel can display the corresponding image content. For example, when the voltage difference reaches the positive operating voltage value +Vop, the corresponding pixel displays white; when the voltage difference reaches the negative operating voltage value −Vop, the corresponding pixel displays black. As can been seen in FIG. 6, for each pixel, when the voltage level of the data driving signal is held at +⅓Vop volts, the data driving signal is in a writing state, and the corresponding pixel displays white. When the voltage level of the data driving signal is held at −⅓Vop volts, the data driving signal is also in the writing state and the corresponding pixel displays black. When the voltage level of the data driving signal is held at 0 volts, the data driving signal is in a non-writing state. Moreover, when the scan driving signal is a pulse signal (voltage level is between +⅔Vop volts to −⅔Vop volts), the scan driving signal is in a scan selection state. When the voltage level of the scan driving signal is held at 0 volts, the scan driving signal is in a non-scan selection state. In such a situation, for each pixel, when the corresponding scan driving signal is in the scan selection state and the corresponding data driving signal is in the writing state, the voltage difference of the corresponding scan driving signal and data driving signal is equal to the positive operating voltage value +Vop (or the negative operating voltage value −Vop). In other words, because the corresponding voltage difference has exceeded the threshold voltage value, the corresponding pixel can reach the target reflectance and realize the desired image display. In addition, when the corresponding scan driving signal is in the non-scan selection state, the voltage difference of the corresponding scan driving signal and data driving signal will be smaller than the positive operating voltage value +Vop and greater than the negative operating voltage value −Vop, i.e. the voltage difference between the corresponding scan driving signal and data driving signal will be between the positive operating voltage value +Vop and the negative operating voltage value −Vop, so as to avoid the erroneous display.

According to the driving procedure 50, in Step 502, the timing control circuit 310 can generate the data control signal STCON_C and the driving control signal STCON_R according to image data I. Furthermore, in Step 504, the data driving circuit 312 can generate the data driving signals SC1 to SCm to the second conductive electrodes C1 to Cm according to the data control signal STCON_C. Preferably, the data driving circuit 312 can generate data driving signals SC1 to SCm corresponding to a specific pixel row to the second conductive electrodes C1 to Cm every one pixel display period according to the driving control signal STCON_R. For example, as shown in FIG. 7, the data driving circuit 312 generates data driving signals SC1 to SCm respectively corresponding to the pixels (R1, C1) to (R1, Cm) for the second conductive electrodes C1 to Cm during the pixel display period T1. The data driving circuit 312 generates data driving signals SC1 to SCm respectively corresponding to the pixels (R2, C1) to (R2, Cm) for the second conductive electrodes C1 to Cm during the pixel display period T2; and so on and so forth.

In Step 506, the scan driving circuit 314 can generate scan driving signals SR1 to SRn to the first conductive electrodes R1 to Rn according to the driving control signal STCON_R. Preferably, the scan driving circuit 314 can sequentially generate a corresponding scan driving signal to the corresponding first conductive electrode every one pixel display period according to the driving control signal STCON_R. For example, as shown in FIG. 7, the scan driving circuit 314 generates the scan driving signal SR1 to the first conductive electrodes R1 during the pixel display period T1. The scan driving circuit 314 generates the scan driving signal SR2 to the first conductive electrodes R2 during the pixel display period T2; and so on and so forth. Note that, the scan driving signals can be generated sequentially, and this is not a limitation of the invention. For example, the scan driving circuit 314 can generate a scan driving signal to a corresponding first conductive electrode everyone pixel display period in random order or in a specific order. Meanwhile, the data driving circuit 312 is able to generate the corresponding data driving signals for the pixel row selected by the scan driving circuit 314.

Therefore, through the steps of the driving procedure 50, each pixel can display the corresponding grey level according to the voltage difference between the corresponding first conductive electrode and second conductive electrode so as to realize the display purpose of the image data I. Please further refer to FIG. 7. During the pixel display period T1, voltage level of the data driving signal SC1 is held at +⅓Vop volts, and voltage level of the scan driving signal SR1 is between +⅔Vop volts and −⅔Vop volts. In such a situation, the voltage difference between the data driving signal SC1 and the scan driving signal SR1 is between Vop volts and −⅓Vop volts. In other words, the voltage difference between the data driving signal SC1 and the scan driving signal SR1 has reached the positive operating voltage value +Vop so that the pixel (R1, C1) can display white accordingly (as can been seen in FIG. 8). Similarly, during the pixel display period T1, voltage level of the data driving signal SC2 is held at −⅓Vop volts so that the pixel (R1, C2) can display black accordingly (as can been seen in FIG. 8). In brief, during the pixel display period T1, the pixels (R1, C1) to (R1, Cm) can represent the corresponding pixel image respectively according to the driving signals generated by the data driving circuit 312 and the scan driving circuit 314. Also, during the pixel display period T1, the scan driving circuit 314 does not generate a corresponding pulse signal to the first conductive electrodes R2 to Rn, i.e. the scan driving signals SR2 to SRn are held at 0 volts, so that the voltage difference of each data driving signal of the data driving signals SC2 to SCm and the corresponding scan driving signal is between +⅓Vop volts and −⅓Vop volts without exceeding the positive threshold voltage value +Vth (or being smaller than the negative threshold voltage value −Vth). This means that the pixel display will be not changed in the non-scan selection state. After that, as shown in FIG. 7, during the pixel display period T2, the pixels (R2, C1) to (R2, Cm) can represent the corresponding pixel image respectively according to the driving signals generated by the data driving circuit 312 and the scan driving circuit 314; and so on and so forth. In the following pixel display periods, each pixel can display the corresponding pixel image data according to the scan order of the scan driving circuit 314. As a result, the scan driving circuit 314 can generate a corresponding scan driving signal to the corresponding first conductive electrode according to a specific order every one pixel display period for scanning each pixel row. The data driving circuit 312 can generate the data driving signals corresponding to the specific pixel row with the scan order of the scan driving circuit 314 for achieving the display purpose of the image data I.

On the other hand, in Step 506, the scan driving signal can be a single period pulse signal or a multiple period pulse signal. For example, in FIG. 7, the scan driving signals SR1 to SRn are respectively two period pulse signals, i.e. each of the scan driving signals SR1 to SRn includes two period (Tw) cycles. Preferably, a setting time can be reserved before the beginning of each pulse signal, or a holding time can be reserved after the end of each pulse signal for a buffer period to avoid erroneous image display caused by a transmission delay effect of the corresponding data driving signal. For example, as shown in FIG. 7, a setting time Ts is reserved before the beginning of each pulse signal and a holding time Th is reserved after the end of each pulse signal.

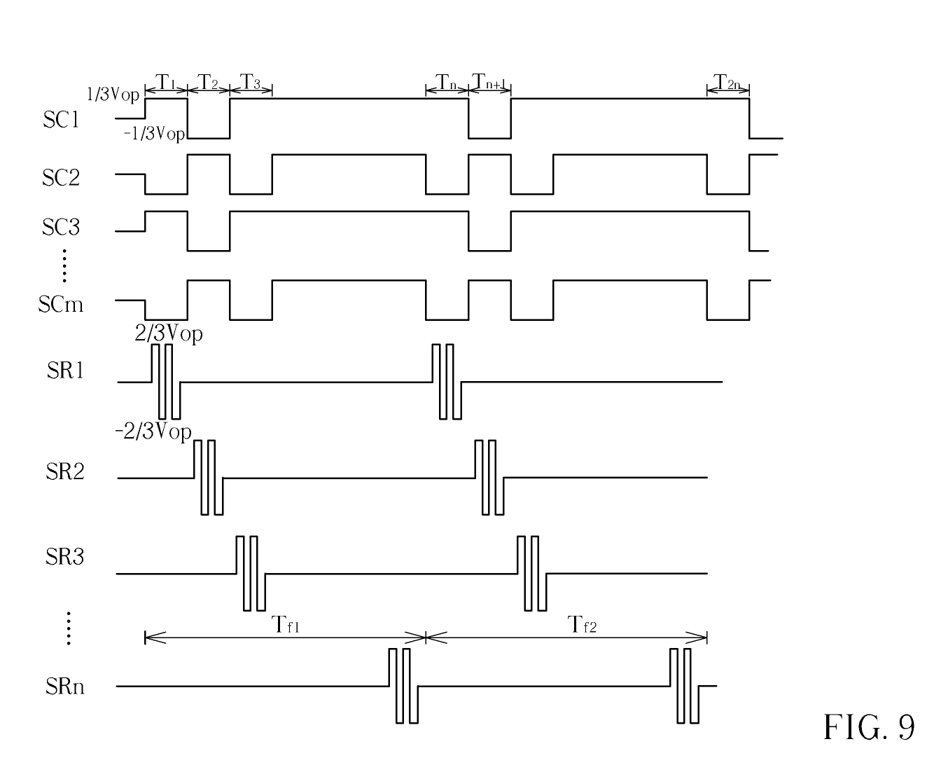

In addition, the bistable display apparatus 30 can use multiple scans for displaying a single image data. The bistable display apparatus 30 can realize a writing purpose of the single image data through a multiple circular scanning manner. Please refer to FIG. 9, which is a timing chart of relative signals under multiple scanning operation according to an embodiment of the present invention. Suppose an image data I can be displayed. As shown in FIG. 9, during an image display period Tf1, the scan driving circuit 314 sequentially generates scan driving signals SR1 to SRn for displaying the image data I. After that, during an image display period Tf2, the scan driving circuit 314 further sequentially generates scan driving signals SR1 to SRn for displaying the following image data I. Therefore, for each pixel, scan length of the scan driving signals can be changed and the amount of circular scanning can be increased to make each pixel achieve the target reflectance value to display the corresponding pixel grey level.

Note that the above-mentioned embodiments represent exemplary embodiments of the present invention, and those skilled in the art can make alterations and modifications accordingly. For example, the signal setting values shown in FIG. 6 are only one exemplary embodiment of the present invention, and other signal setting values which can achieve the same purpose are available. In addition, the voltage threshold value can be changed through various materials or structures of the components of the bistable display apparatus 30.

In summary, for application requirements of the dot matrix display apparatus, the present invention utilizes a patterned arrangement structure of the first conductive electrodes and second conductive electrodes to replace the conventional entire transparent conductive layer for forming a pixel array, and therefore, achieves the image display by pixel array accordingly based on the electro-phoretic display technology. Compared with the conventional dot matrix display with a thin film transistor array, the present invention requires only a simple lamination manufacturing process to achieve a dot matrix pixel structure without a complicated semiconductor manufacturing process. Furthermore, the present invention can realize dot matrix image display by the collaborative control operation of the timing control circuit, the data driving circuit, and the scan driving circuit. Accordingly, the bistable display apparatus of the present invention needs a simple manufacturing process and is capable of reducing the manufacturing cost. Moreover, because the electro-phoretic display is adapted to be applied to a flexible substrate, the bistable display apparatus of the present invention is able to provide the user with a more convenient portable display product.

Those skilled in the art will readily observe that numerous modifications and alterations of the device and method may be made while retaining the teachings of the invention.

What is claimed is:

1. A bistable display apparatus with dot-matrix pixels, comprising:
a front substrate;
a plurality of first conductive electrodes disposed below the front substrate and parallel to each other along a first direction;
an electrophoretic medium layer disposed below the front substrate and the plurality of first conductive electrodes;
a back substrate; and
a plurality of second conductive electrodes disposed on the back substrate and parallel to each other along a second direction different from the first direction;
wherein a pixel is formed at each intersection of each first conductive electrode and each second conductive electrode.

2. The bistable display apparatus of claim 1 further comprising an adhesive layer disposed between the electrophoretic medium layer and the plurality of second conductive electrodes.

3. A bistable display apparatus with dot-matrix pixels, comprising:
a front substrate;
a plurality of first conductive electrodes disposed below the front substrate and parallel to each other along a first direction;
an electrophoretic medium layer disposed below the front substrate and the plurality of first conductive electrodes;
a back substrate; and
a plurality of second conductive electrodes disposed on the back substrate and parallel to each other along a second direction different from the first direction, wherein a pixel is formed at each intersection of each first conductive electrode and each second conductive electrode;
a timing control circuit for generating a data control signal and a driving control signal;
a data driving circuit coupled to the timing control circuit and the plurality of second conductive electrodes for generating a plurality of data driving signals to the plurality of second conductive electrodes according to the data control signal; and
a scan driving circuit coupled to the timing control circuit and the plurality of first conductive electrodes for generating a plurality of scan driving signals to the plurality of first conductive electrodes according to the driving control signal.

4. The bistable display apparatus of claim 3 further comprising an adhesive layer disposed between the electrophoretic medium layer and the plurality of second conductive electrodes.

5. The bistable display apparatus of claim 3, wherein the scan driving circuit sequentially generates a corresponding scan driving signal to the corresponding first conductive electrode everyone pixel display period according to the driving control signal.

6. The bistable display apparatus of claim 5, wherein when the corresponding scan driving signal is in a scan selection state, the corresponding scan driving signal is a pulse signal.

7. The bistable display apparatus of claim 6, wherein when the corresponding data driving signal is in a writing state, the corresponding data driving signal is held at a high data voltage level or a low data voltage level.

8. The bistable display apparatus of claim 7, wherein when the corresponding data driving signal is held at the high data voltage level, the difference of the high data voltage level and the lowest voltage level of the corresponding scan driving signal is greater than a positive threshold voltage.

9. The bistable display apparatus of claim 7, wherein when the corresponding data driving signal is held at the low data voltage level, the difference of the low data voltage level and the highest voltage level of the corresponding scan driving signal is smaller than a negative threshold voltage.

10. The bistable display apparatus of claim 6, wherein duration of the pulse signal is shorter than length of the pixel display period.

11. The bistable display apparatus of claim 5, wherein when the corresponding scan driving signal is in a non-scan selection state, the voltage difference of the corresponding data driving signal and scan driving signal is between a positive threshold voltage and a negative threshold voltage.

12. A driving method for a bistable display apparatus, comprising:
providing the bistable display apparatus, the bistable display apparatus comprising a front substrate, a plurality of first conductive electrodes disposed below the front substrate and parallel to each other along a first direction, an electrophoretic medium layer disposed below the front substrate and the plurality of first conductive electrodes, a back substrate, and a plurality of second conductive electrodes disposed on the back substrate and parallel to each other along a second direction different from the first direction, wherein a pixel is formed at each intersection of each first conductive electrode and each second conductive electrode;
generating a data control signal and a driving control signal;
generating a plurality of data driving signals to the plurality of second conductive electrodes according to the data control signal; and
generating a plurality of scan driving signals to the plurality of first conductive electrodes according to the driving control signal.

13. The driving method of claim 12, wherein the step of generating the plurality of scan driving signals to the plurality of first conductive electrodes according to the driving control signal comprises sequentially generating a corresponding scan driving signal to the corresponding first conductive electrode everyone pixel display period according to the driving control signal.

14. The driving method of claim 13, wherein when the corresponding scan driving signal is in a scan selection state, the corresponding scan driving signal is a pulse signal.

15. The driving method of claim 14, wherein when the corresponding data driving signal is in a writing state, the corresponding data driving signal is held at a high data voltage level or a low data voltage level.

16. The driving method of claim 15, wherein when the corresponding data driving signal is held at the high data voltage level, the difference of the high data voltage level and the lowest voltage level of the corresponding scan driving signal is greater than a positive threshold voltage.

17. The driving method of claim 15, wherein when the corresponding data driving signal is held at the low data voltage level, the difference of the low data voltage level and the highest voltage level of the corresponding scan driving signal is smaller than a negative threshold voltage.

18. The driving method of claim 14, wherein duration of the pulse signal is shorter than length of the pixel display period.

19. The driving method of claim 13, wherein when the corresponding scan driving signal is in a non-scan selection state, the voltage difference of the corresponding data driving signal and scan driving signal is between a positive threshold voltage and a negative threshold voltage.
